(19) United States
(12) Patent Application Publication
(10) Pub. No.: US 2011/0235168 A1
(43) Pub. Date: Sep. 29, 2011

(54) STERILE CONTROL UNIT WITH A SENSOR SCREEN

(75) Inventor: Ulrich Sander, Rebstein (CH)

(73) Assignee: LEICA MICROSYSTEMS (SCHWEIZ) AG, Heerbrugg (DE)

(21) Appl. No.: 13/070,255

(22) Filed: Mar. 23, 2011

(30) Foreign Application Priority Data
Mar. 26, 2010 (DE) 10 2010 003 339.1

(51) Int. Cl. G02B 21/00; G06F 3/042

(52) U.S. Cl. 359/368; 345/176; 345/175

(57) ABSTRACT

The present invention relates to a control unit for an item of medical equipment, particularly a surgical microscope, for controlling equipment functions, comprising a sensor-screen having a sensor-screen surface for displaying image material, the sensor-screen being configured to be operated in contactless manner via a recognition device and to accommodate a sterile transparent control surface in front of the sensor-screen surface.

### CROSS-REFERENCE TO RELATED APPLICATION

This application claims the priority of the German patent application DE 102010003339.1 having a filing date of Mar. 26, 2010. The entire content of this prior German patent application DE 102010003339.1 is herewith incorporated by reference.

### BACKGROUND OF THE INVENTION

The present invention relates to a control unit for an item of medical equipment.

Although the description that follows relates essentially to microscope systems the invention is not restricted thereto, but can be used as a control unit for all kinds of medical equipment in which sterile operation is important. By this is meant medical apparatus used in sterile environments such as operating theatres, for example. Medical equipment of this kind for the purposes of the invention includes for example surgical or operating microscopes, phacoemulsifiers, anaesthesia machines, heart-lung machines, suction and rinsing equipment, light controls, table adjusters, electric counters, etc.

One factor common to all medical equipment of this kind is the fact that they have to conform to stringent sterility requirements for use in an operating theatre. It is desirable that the input units, keyboards or control consoles for them should also be sterilisable so that the surgeon himself or other sterile staff can operate these medical apparatus without becoming unsterile. It is also desirable for the surgeon to be able to carry out operations without having to rely on assistants.

A touch-screen, touch-sensitive screen or sensor-screen is an input device with which the running of the programme of an item of technical equipment such as, in this case, medical equipment, can be controlled by touching parts of an image or by pointing to parts of an image. The image is generated dynamically using a monitor.

It is known to actuate microscopes, including surgical microscopes, using touch-screens. For example, the Assignee sells a microscope system of the type in question under the reference M720 (cf. the brochure for Leica Microsystems (Schweiz) AG, Leica M720 0H5, 10 M1 151 Ode/-, IV.2008). The microscope systems are equipped with conventional capacitive or resistive touch-screens, but this gives rise to problems particularly in the medical field and in this case especially in the operating theatre.

The operator who uses a microscope system of this kind for the operation encounters difficulties with respect to its actuation in the prior art. Admittedly, microscope systems of this kind are very easy to operate using the touch-screen, but it is precisely this that gives rise to problems of hygiene and sterility as a touch-screen cannot be sterilised to the degree required. The alternatives of applying sterile films to the touch-screen glass, or packaging it in sterile bags, as is common practice with other equipment in the operating theatre, are not possible, as the presence of the film alters the capacitive or resistive properties in such a way that precise control is no longer possible. As a result, for reasons of hygiene, standard commercial microscope systems equipped with a touch-screen have to be operated in the operating theatre by a person specially employed for that purpose, usually a theatre nurse, and not by the operating surgeon himself. This requires the deployment of additional staff and also, as a result of misunderstandings between the operating surgeon and the nurse, incorrect actuation of the equipment may occur.

As an improvement, DE 10 2005 018 431 A1 describes a surgical microscope with at least one input unit having at least one display and at least one touch-activated control field, the touch-activated control field being antimicrobial, e.g. as a result of the addition of silver, copper or other chemical substances with antimicrobial properties. However, an antimicrobial activity is not sufficient to create sterility. As a result, this microscope cannot be operated by the surgeon himself either.

DE 10 2006 019 864 A1 describes a medical-technical apparatus for a sterile environment with an input unit for controlling the functions of the medical-technical apparatus, the input unit being configured as a virtual projection keyboard. This solution certainly provides the option of sterile actuation, but the advantages of a graphic display (particularly a moving image display), of the type conventionally obtained with touch-screens, are lost.

### SUMMARY OF THE INVENTION

It is therefore an object of the present invention to provide a control unit for medical equipment that comprises a touch-screen and can be actuated in sterile manner.

According to a first aspect of the present invention, this object is achieved by a control unit of a medical device, the control unit being adapted to control device functions, wherein the control unit comprises a sensor screen with a sensor screen surface for displaying an image material; and the sensor screen is configured to be operated in contact-free manner by proximity recognition and is adapted to hold a sterile transparent control face element in front of the sensor screen surface.

According to a second aspect of the present invention, this object is achieved by a microscope apparatus comprising a surgical microscope and a control unit, the control unit being adapted to control microscope functions, wherein the control unit comprises a sensor screen with a sensor screen surface for displaying an image; and the sensor screen is configured to be operated in a contact-free manner by proximity recognition and is adapted to hold a sterile transparent control face element in front of the sensor screen surface.

### DETAILED DESCRIPTION OF THE INVENTION

The invention creates the possibility of providing medical equipment (e.g. microscope systems) with sensor-screen control units which are also suitable for actuation by an operator in an operating theatre under sterile conditions. In particular, conventional capacitive or resistive touch-screens which require the touch-screen to be touched by the operator himself are replaced by sensor-screens which can be actuated in contactless manner (“touchless touch-screen”). Contactless recognition can be provided in particular by means of recognition devices, such as e.g. a light curtain, that record the location of the approach. To provide the necessary sterility the sensor-screen surface is equipped with a transparent sterile control surface. The sensor-screen is therefore suitable for receiving a sterile operating surface in front of the sensor-screen surface whilst maintaining its functionality. During operation, the surgeon is protected from coming into contact with the non-sterile sensor-screen surface by the sterile control surface. Direct contact between the surgeon and the sensor-screen is avoided.

The sterile control surface is expediently a sterile and/or sterilisable panel (of glass or plastics, for example) or a sterile film that can be applied thereto. According to an advantageous feature, the sterile control surface may be reusable, in which case it will also be designed to be sterilisable. According to an alternative feature, a plastic sheet or sterile film may be used as a sterile single-use or disposable article.

Preferably, the sensor-screen has fixing means such as e.g. snap-on, latching or other mechanisms that enable the sterile control surface to be attached easily in front of the sensor-screen.

A control unit according to the invention is preferably suitable for operating or controlling a microscope system comprising a surgical microscope, a phacoemulsifier, an anaesthesia machine, a heart-lung machine, suction and rinsing equipment, light controls, table adjusters, electro couters, etc. A control unit according to the invention may also be provided to control a plurality of these items of equipment, thus leading to a saving on control units and hence a saving in space and costs.

Further advantages and embodiments of the invention will become apparent from the description and the accompanying drawings.

It will be understood that the features mentioned above and those that are to be explained hereinafter may be used not only in the particular combination specified but also in other combinations or on their own, without departing from the scope of the present invention.

The invention is schematically shown in the drawings by means of an embodiment by way of example and is hereinafter described in detail with reference to the drawings.

### BRIEF DESCRIPTION OF THE DRAWINGS

FIG. 1 schematically shows a preferred embodiment of a microscope system according to the invention.

### DETAILED DESCRIPTION OF THE DRAWINGS

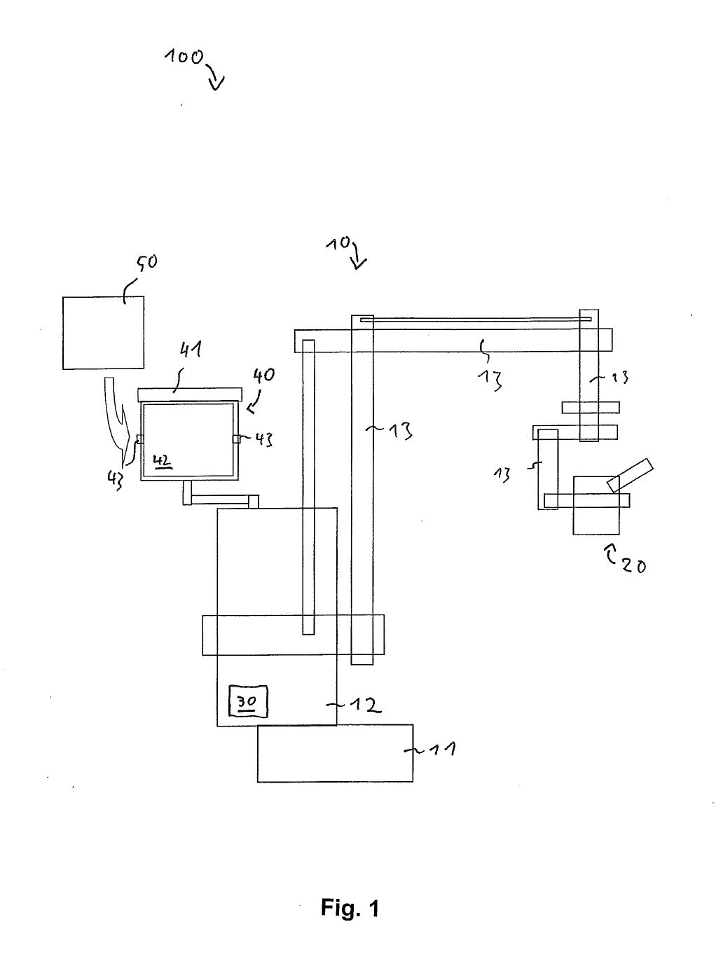

FIG. 1 schematically shows a preferred embodiment of a microscope system according to the invention which is generally designated 100. The microscope system 100 has a surgical microscope 20 which is supported on a stand 10 and is mounted on the stand 10 so as to be movable in all three spatial directions (in translatory and rotary movement).

The stand 10 comprises a foot 11 on which a stand body 12 is rotatably mounted. The stand further comprises a number of arms 13 that support the operating microscope 20 and ensure that it is movable in space. The body 12 of the stand houses inter alia units (not shown) for supplying the microscope system with power and the like and a control unit 30 for the microscope system.

Associated with the control unit 30 for controlling the microscope functions is a preferred control unit, which in this instance is configured as an optical sensor-screen 40. The sensor-screen 40 is configured such that it can be operated in the sterile environment, such as e.g. in an operating theatre, by the operating surgeon. The sensor-screen 40 comprises in particular a sensor-screen surface or display 42 for displaying image material. The image material comprises, at least in part, areas that are intended for controlling the functions of the microscope system. In a surgical microscope, these functions are, for example, the function of moving the operating microscope, such as movement along X-Y, but also in Z (height), controlling the zoom (magnifying function), focussing, releasing and applying brakes, etc. Other functions that should advantageously be controlled by the surgeon himself using this sensor-screen may be, for example, fading additional information or images in or out, controlling additional viewer outputs, shutters or specific viewing modes (brightness, contrast, contours) etc.

In the embodiment shown here, the optical sensor-screen 40 comprises a light curtain 41 as a recognition device which comprises inter alia an infra-red light source and computer-controlled cameras and deflecting mirrors for detecting the position of the user's finger on or in front of the sensor-screen surface 42 and for sending the detected data to the control unit 30.

In the embodiment shown here, the sensor-screen 40 is equipped with fixing means 43 that may be in the form of a snap-on or latching mechanism, for example, so as to accommodate a transparent replaceable panel 50 as a sterile control surface. The panel 50 may be a reusable sterilisable panel, a sterile single-use or disposable article or another item that is suitable for providing a sterile transparent operating surface. For example, it may also be a sterile film that can be stuck on and removed. In addition to the fixing means 43 for the sterile control surface the sensor-screen 40 may also comprise fixing means (not shown) for a so-called drape (sterile bag) so that the sensor-screen as a whole can be surrounded by sterile packaging.

It will be understood that the type of recognition device that can be operated without contact (e.g. a light barrier, light curtain, light grid, etc.) is not directly or functionally related to the nature of the sterile control surface (e.g. film, panel, etc.). E.g., a so called “infrared touch screen” can be provided, which uses an array of X-Y infrared LED and photodetector pairs around the edges of the screen to detect a disruption in the pattern of LED beams.

Thus, the solution according to the invention provides a sterile control unit for medical equipment, for example a microscope system comprising a surgical microscope, having a sensor-screen that can be operated in sterile manner and thus, in particular, is not subject to the disadvantages mentioned above with regard to the need for staff and errors in communication between the surgeon and the operator. The invention makes it possible to overcome the disadvantages linked with conventional resistive or capacitive touch-screens.

What is claimed is:

1. A control unit of a medical device, the control unit being adapted to control device functions, wherein the control unit comprises:
a sensor screen with a sensor screen surface for displaying an image material; and
the sensor screen is configured to be operated in contact-free manner by proximity recognition and is adapted to hold a sterile transparent control face element in front of the sensor screen surface.

2. The control unit according to claim 1, wherein the sensor-screen is an optical sensor screen comprising an optical recognition device.

3. The control unit according to claim 2, wherein the optical recognition device comprises at least one of a camera, a light barrier, a light curtain and a light grid.

4. The control unit according to claim 2, wherein the optical sensor screen is an infrared sensor screen.

5. The control unit according to claim 1, wherein the sensor screen comprises a fixing element for holding the transparent control face element.

6. The control unit according to claim 1, wherein the sterile control face element is reusable and sterilisable.

7. The control unit according to claim 6, wherein the transparent sterile control face is replaceable.

8. The control unit according to claim 1, wherein the transparent sterile control face element is one of a sheet of glass and plastics and film.

9. A microscope apparatus comprising a surgical microscope and a control unit, the control unit being adapted to control microscope functions, wherein the control unit comprises:
a sensor screen with a sensor screen surface for displaying an image; and
the sensor screen is configured to be operated in a contact-free manner by proximity recognition and is adapted to hold a sterile transparent control face element in front of the sensor screen surface.

10. Microscope apparatus according to claim 9, having a stand that supports the operating microscope and the control unit.
